(19) United States
(12) Patent Application Publication
(10) Pub. No.: US 2013/0012313 A1
(43) Pub. Date: Jan. 10, 2013

(54) TABLET COMPUTER GAME DEVICE

(75) Inventor: Robert Chen, San Marino, CA (US)

(73) Assignee: RAZOR USA, LLC, Cerritos, CA (US)

(21) Appl. No.: 13/492,692

(22) Filed: Jun. 8, 2012

Related U.S. Application Data
(60) Provisional application No. 61/495,933, filed on Jun. 10, 2011.

(51) Int. Cl. A63F 13/02; A63F 9/24

(52) U.S. Cl. 463/31; 463/36; 463/35; 463/30

(57) ABSTRACT

A game piece includes conductive touch points. The conductive touch points are configures to contact a touchscreen of a computing device and register a touch event with the computing device. The game pieces may include an input component that can receive signals from the touchscreen device and generate an effect based on the signals. Game pieces may include momentary touch points allowing for variable game play. Game pieces may also have different touch point patterns allowing the touchscreen computing device to generate effects or responses based on the touch point pattern of the game piece.

### CROSS-REFERENCE TO RELATED APPLICATIONS

This application claims priority from U.S. Provisional Application No. 61/495,933, filed Jun. 10, 2011, which is hereby incorporated by reference in its entirety.

### BACKGROUND

1. Field of the Disclosure

Embodiments disclosed herein relate generally to games and game apparatuses used in conjunction with touch screen computers, namely tablet-style computing devices including mobile personal computing devices.

2. Related Art

Recently, tablet-style computing devices have greatly increased in popularity. Developments in technology have allowed for increased portability of these personal computing devices, while at the same time increasing computing power and graphics rendering abilities of the devices. This includes devices such as mobile phones with computing capabilities (also known as “smartphones”), and tablet-style personal computing devices (also known simply as “tablets”). This has allowed for a greatly increased array of uses for which these mobile personal computing devices have been put to use by consumers including e-mail, internet, personal organization, games, and various other utility and entertainment applications. Additionally, these devices have incorporated new advancements in touchscreen technology, allowing for the user to act upon the mobile device through touch and touch gestures with a pen-type device (also known as a “stylus”) or other interaction means, and even a human finger. Touchscreen enabled devices have eliminated the need for physical input devices or modules such as keyboards and computer mice and have allowed novice users to easily learn how to operate these devices due to their simplicity and natural interaction.

Previously, touchscreens incorporated into computing device displays generally utilized resistive touch display technology. These types of resistive touch displays are generally comprised of thin, electrically conductive layers separated by a narrow gap, with an overlay of a transparent substrate defining a touch area. The resistive touch display registers input when the user touches a point on the touch area's surface with the user's finger or stylus-type device, thereby causing the thin, conductive layers to be connected at that point by the downward pressure of the user's input. The touch between the thin, conductive layers causes a change in the electrical current at a certain known location which is registered as a touch event and sent to the computing unit for processing.

Recently however, many mobile personal computing devices have moved away from resistive touch screen displays and incorporated capacitive touch screen technology. Generally, a capacitive touch screen is comprised of a glass display with a conductive coating through which an electrostatic field is generated by the device. When the user touches the surface of the screen using a human finger or other conductive object, the touch causes a distortion of the screen's electrostatic field at a certain known location which is registered as a touch event and sent to the computing unit for processing. This allows for capacitive touchscreens to detect and register user input with little to no physical pressure or force applied on the touch area. Thus, the user is able to interact and operate the touchscreen device with a very light touch, as well as using input gestures such as a swipe, flick, or double tap. Further advancements have also allowed for multiple touch inputs on a capacitive touchscreen to be registered at one time (also known as “multi-touch” capability). Multitouch gestures such as pinching, rotating, or swiping with multiple fingers have also been implemented.

### SUMMARY

The present disclosure describes, among other things, a game piece apparatus for interacting with a touch screen computing device includes a plurality of conductive touch points and an input component for receiving an input signal from a touchscreen computing device. The game piece apparatus may also include one or more effect generators that generate an effect in response to the input component receiving an input signal from the touchscreen computing device. The input unit may be a photo sensor or an audio input unit. Additional embodiments of the game piece apparatus may also include: a battery, a medium for storing the input signal, a momentary touch point, and a conductive contact surface connected to the plurality of conductive touch points via a low-resistance conductive material. The one or more effect generators may produce visual, auditory, or tactile effects.

The present disclosure additionally describes, among other things, a method for providing an interactive computing application. The method includes detecting a first pattern of first touch points, the first touch points affixed to a first game piece and detecting a second pattern of second touch points, the second touch points affixed to a second game piece wherein the second pattern of touch points is different from the first pattern of touch points. A first signal communicating a first message instructing the first game piece to generate a first effect is generated and a second signal communicating a second message instructing the second game piece to generate a second effect is generated. The first signal, message and effect are different from the second signal, message and effect. The first signal and the second signal may be capable of being detected by a photo sensor or an audio input device.

The present disclosure additionally describes, among other things, a computer-readable, non-transitory storage medium having one or more computer-executable modules that detect a pattern of conductive touch points of a game piece through a touchscreen, determine a first effect to generate based at least in part on the detected pattern of conductive touch points, detect at least one additional conductive touch point, the at least one additional conductive touch point making contact with the touchscreen at the same time as pattern of conductive touch points, determine a second effect to generate based at least in part on the at least one additional conductive touch point, and generating the first and second effect. The first and second effect may be visual or auditory.

### BRIEF DESCRIPTION OF THE DRAWINGS

These and other features, aspects and advantages of the present devices and methods are described with reference to drawings of preferred embodiments, which are provided for the purpose of illustration and not limitation. The drawings contain nine (9) figures.

FIG. 1 illustrates two examples of embodiments of game pieces, each with a different touch point pattern on the bottom of the game piece.

FIG. 2 illustrates one example embodiment of a game piece in contact with one embodiment of a touch screen computing device.

FIG. 3 illustrates several example embodiments of game pieces. One embodiment comprises three touch points and one photo sensor. One embodiment comprises an LED light on the top of the game piece. One embodiment comprises an LCD display on the top of a game piece.

FIG. 4 illustrates a side view of one embodiment of a game piece. The game piece comprises a contact surface connecting touch points via a conductive material.

FIG. 5 illustrates a block diagram of the components of a game piece according to one embodiment.

FIG. 6 illustrates a flow chart for a touchscreen computing device detecting a game piece, generating a response message and a game piece receiving the response message and generating an effect according to one embodiment.

FIG. 7 shows a flow chart for detecting two game pieces with different touch point patterns and generating a response for each game piece according to one embodiment.

FIG. 8 shows one embodiment of a sample educational application

FIG. 9 shows one embodiment of a sample entertainment application.

### DETAILED DESCRIPTION

### Overview

As touchscreens become more prevalent in mobile and personal computing devices, video games in particular have benefited from the wide array of input method combinations made available by the technology. Games have consistently been extremely popular with mobile computing users of all levels and experience due to their entertainment value and convenience. Generally, games can be purchased by users or downloaded for free directly onto a mobile computing device from online application stores, commonly known as “app stores” or “app markets”. Many of these games take advantage of the input capabilities of capacitive touchscreen devices, often incorporating inputs such as touches, taps, swipes, flicks, long touches, and various multi-touch gestures into a game's controls.

In many games, game developers have replaced hard wired button inputs found in video game controllers with virtual buttons displayed to the user on the touchscreen, also known as “soft input” buttons. This allows for the soft input buttons to change to appropriately match the context or the state of the game being displayed at any given moment. Generally, due to the characteristics of the capacitive touchscreen technology, the input must be registered with the user's finger or fingers and games are not able to incorporate real world object game pieces or other controllers to interact with the game through the touchscreen. Even where an object has conductive characteristics to register a touch event on a capacitive touchscreen, current games are not configured to meaningfully interact with real world objects or game pieces. This limits game and application development to incorporating input from the user's fingers or a stylus-type device only, where a more enjoyable and immersive experience may be created by incorporating real world game pieces or objects that are able to meaningfully interact with the game or application. Therefore, the current games and game pieces for touchscreen computing devices are not adequately configured to allow for a fully interactive and enjoyable experience by the user. Such interaction between games and real world game pieces will also allow for young children or novice users to learn quickly and enjoy applications or games as the interactions and controls will come more naturally.

Embodiments of the game pieces disclosed herein may be configured to allow a user to use the game piece to meaningfully interact and control aspects of a computer game or application through a computing device's touchscreen. A user can place the game piece on a touchscreen to register touch events on the computing device. The game piece may include contact points interfacing with a computing device's touchscreen to create touch events. The contact points may be made of a conductive or semi-conductive material such as, for example, conductive rubber, conductive foam, anti-static foam, conductive metals or some other well known conductive material.

The software applications described herein may be configured to operate on touchscreen enabled devices such as smartphones and tablets (“touchscreen devices”). The software applications may be configured to detect and register single touch events by the user's finger or stylus-type device. In some embodiments, the touchscreen devices may be configured to detect and register pre-defined unique touch patterns of game pieces to trigger events, actions, reactions, and other state changes. Furthermore, in some embodiments, software executing on the touchscreen devices may be configured to detect and register multiple pre-defined unique touch patterns of game pieces at one time, each unique touch pattern generating or triggering its own event, action, reaction, and other game state changes.

Reference will now be made in detail to the alternative embodiments of the present technology. While numerous specific embodiments of the present technology will be described in conjunction with the alternative embodiments, it will be understood that they are not intended to limit the present technology to these embodiments. On the contrary, these described embodiments of the present technology are intended to cover alternatives, modifications and equivalents. Furthermore, in the following detailed description, numerous specific details are set forth in order to provide a thorough understanding of the present technology. However, it will be recognized by one of ordinary skill in the art that embodiments may be practiced without these specific details. In other instances, well known methods, procedures, components, compositions and mechanisms have not been described in detail as not to unnecessarily obscure aspects of embodiments of the present technology.

### Description of Game Pieces

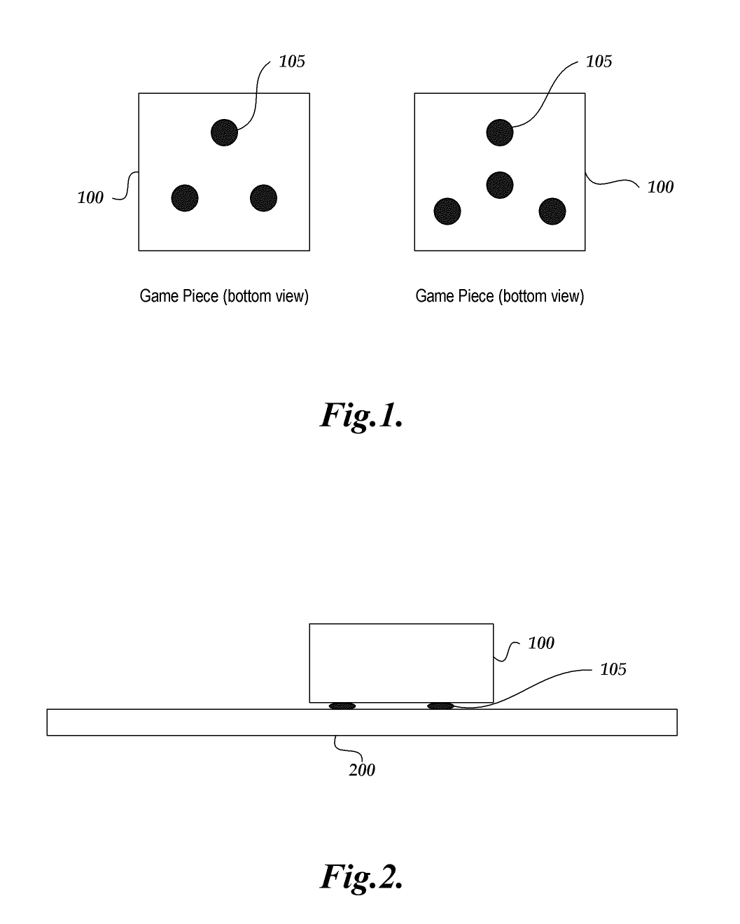

FIG. 1 illustrates two examples of embodiments of game pieces 100, each with a different touch point pattern on the bottom of the game piece. The bottom of each game piece 100 may contain one or more touch points 105. The touch points 105 may be made of a conductive material so that a capacitive touchscreen device registers a “touch” event. FIG. 2 illustrates one example embodiment of a game piece 100 in contact with one embodiment of a touch screen computing device 200 (“touchscreen device”). As shown in the illustrative embodiment of FIG. 2, the touch points 105 of the game piece 100 are the only portion of the game piece to contact the touchscreen device 200. In some embodiments, the touchscreen device 200 may be a capacitive touchscreen device and the touch points 105 may be conductive or carry current so that touch points 105 register contact with the touchscreen device 200. In other embodiments, the touchscreen device may be a resistive touchscreen device. In such embodiments, the touch points 105 may register contact with the touchscreen device 200 through pressure applied to the game piece 100 or from the weight of the game piece 100.

In some embodiments, game pieces 100 are configured so that the touch points 105 of the game piece form a unique pattern thereby creating a unique set of touch points on the touchscreen recognizable by the touchscreen device 200. For example, the touch points 105 may be arranged in different geometric shapes for each game piece 100 that may interact with the touchscreen device. The touch points 105 may be arranged, for example, to uniquely identify different objects that interact with an application executing on the touchscreen computing device.

In some embodiments, the game pieces may be a static representation of a real world object, such as the integers 0-9. In other embodiments, the game pieces may be dynamically assigned a representation the first time the touch points of the game piece contact the screen, and the application running on the touch screen device may “learn” to associate the pattern of touch points on the game piece with a particular user or function of the application. For example, for a two player game application executing on the touchscreen computing device, when first touch points of a first game piece contact the touchscreen, the application may associate the pattern of first touch points with Player 1. When second touch points of a second game piece contact the touchscreen, the application may associate the pattern of second touch points with Player 2. Thus, in this example, the touchscreen computing device has “learned” the game piece associated with each player by detecting the touch points of the game piece. Dynamic assignment of game pieces may be advantageous for marketing purposes; the game pieces may hold a collector or intrinsic value separate from their use with the touchscreen computing device and dynamic assignment allows any random two players to interact with the touchscreen computing device provided the touch points of each player's game pieces are distinct.

In one embodiment, the touch points 105 may be arranged in a unique pattern or may represent a closed figure or polygon. For example, the touch points may be arranged in a triangle, square, hexagon etc. Furthermore, the distance between the touch points may be used by the application executing on the touchscreen computing device to associate the game piece with a player, object, or action. For example, in one embodiment, the pattern may be an equilateral triangle on a first game piece and a right triangle on a second game piece. In another embodiment, different game pieces may have touch points arranged in the same shape, but the distance between the touch points may be of different lengths. For example, in one embodiment, a first game piece may have touch points arranged in an equilateral triangle with sides of 1 cm and a second game piece may have touch points arranged in an equilateral triangle with sides of 0.5 cm.

In some embodiments, applications running on the touchscreen computer devices 200 may be configured to detect one or more game pieces at one time. For example, an application may be able to detect a first game piece with touch points arranged in a first pattern and a second game piece with touch points arranged in a second pattern. In response to the first game piece contacting the touch screen, the touchscreen computing device 200 may generate a first response. In response to the second game piece contacting the touch screen, the touchscreen computing device may generate a second response. In some embodiments, the response may be a visual response. For example, when a first game piece contacts the touchscreen, the touchscreen may display a red triangle. When the second game piece contacts the touchscreen, the touchscreen may display a green triangle. A visual response may not be limited to generating shapes of particular colors, but rather, may employ any graphical response capable by the touchscreen computing device, including but not limited to displaying text, icons, photos, images, colors, shapes, dots, animations, etc. In another embodiment, the response may be auditory. For example, when a first game piece contacts the touch screen the touchscreen computing device may generate a first sound, or tone, such as Middle C (261.626 Hz), and when a second game piece contacts the touch screen, the touchscreen computing device may generate a second sound, or tone, such as D above Middle C (293.665 Hz). An auditory response may only be limited by the capabilities of the touch screen computing device's output. In yet another embodiment, the responses may be tactile. For example, in response to a first game piece contacting the touch screen, the touchscreen computing device may vibrate for one second and when a second game piece contacts the touch screen it may vibrate for two seconds. In other embodiments, the game pieces may comprise a battery for the same purpose. In such embodiments, a user may place the game piece on the touchscreen and then remove their hand, and the touchscreen computing device may maintain a touch event even though the user is no longer touching or holding the game piece.

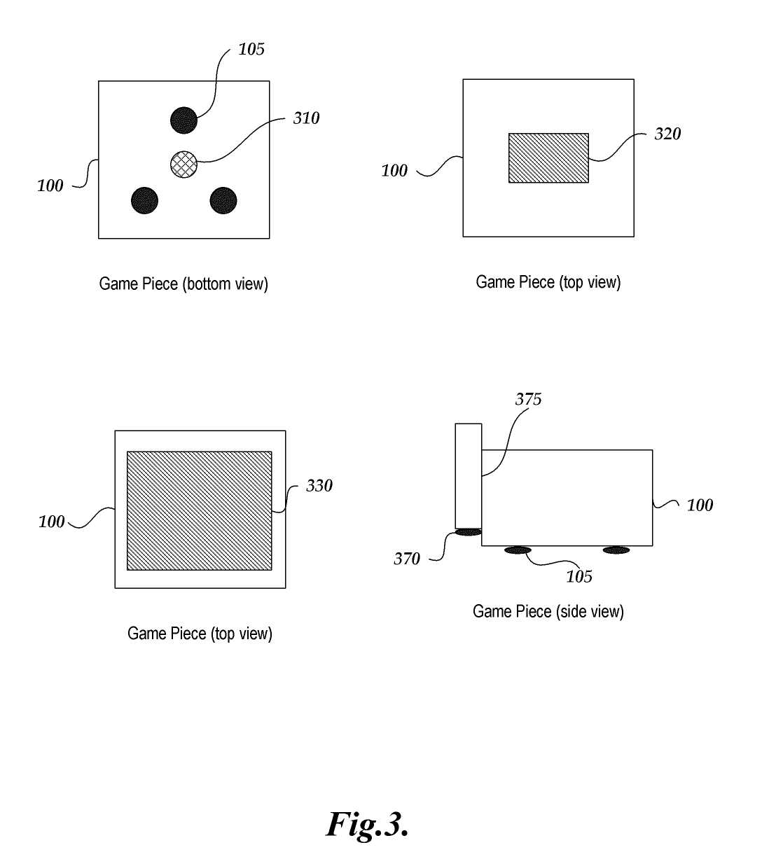

FIG. 3 illustrates several example embodiments of game pieces 100. One embodiment comprises three touch points 105 and one photo sensor 310. One embodiment comprises an LED light 320 on the top of the game piece. One embodiment comprises an LCD display 330 on the top of a game piece. The photo sensor 310, LED light 320, and/or 330 LCD display may be used to facilitate interaction with the touchscreen device 200 of with the person manipulating the game pieces 100.

In some embodiments, the game pieces 100 may comprise a photo sensor 310. The photo sensor 310 may be configured to detect light changes on the touchscreen when the game piece is placed on it. The photo sensor 310 may for example be positioned on the same surface of the game piece 100 as the touch points 105. In some embodiments, the photo sensor 310 may be connected to a portion of the game piece 100 that generates an effect in response to a change in light or color detected by the photo sensor. The effect-generating portion may be the LED light 320, the LCD screen 330 or a speaker for example. For example, in one embodiment, a user may place a game piece 100 on the touchscreen of a touchscreen computing device 200. The touchscreen, detecting the game piece 100, may in response generate a visual effect underneath the game piece. The photo sensor 310 of the game piece may detect the visual effect generated by the touchscreen. In response, the game piece may illuminate an LED light 320 located on the top of the game piece so that the user may see the effect. In some embodiments, the photo sensor 310 may be within an area or shape (e.g., polygon) defined by the touch points 105 such that the light change on the screen can be limited to such an area or shape. In other embodiments, the photo sensor 105 may be outside such an area or shape and the light change on the screen can also extend outside the area or shape.

In some embodiments, the photo sensor 105 may be connected to a memory for storing information. The photo sensor 105 and memory may be configured to store information based on changes in light generated by the touchscreen and detected by the photo sensor. For example, in response to a game piece touching the screen, the touchscreen computing device may flash a light pattern to be detected by the photo sensor 105. The photo sensor may then store the light pattern in the memory. The game piece may use the memory for a later purpose, or may use it for a series of effects. For example, in two player game, a player's score may be transferred from the touchscreen computing device 200 via light to the photo sensor 105. The game piece 100 may then be able to display the score on a surface of the game piece, such as LCD screen 330. The photo sensor may be used to collect other information from the touchscreen in a similar manner.

In some embodiments, the game piece may also comprise a processor and a nontransitory computer readable medium storing software instructions for interpreting light signals generated by the touchscreen and detected by the photo sensor of the game piece. The software instructions may also indicate instructions for generating a response on the game piece. The response of the game piece may be for example, illuminating one or more lights, generating a sound, vibrating, etc.

In some embodiments, the game piece may also comprise a small screen, display or monitor for displaying information, such as LCD screen 300. The software instructions stored on the non-transitory computer readable medium may, in some embodiments, comprise instructions for outputting data to the small screen, display or monitor. The small screen may be a LCD screen for example.

In some embodiments, the game piece 100 may have a momentary touch point 370 that may only contact the touchscreen device 200 when depressed by a user. For example, a game piece may have three touch points 105 that are affixed to the bottom of the game piece 100 and where all three touch points contact the touchscreen device 200 when the game piece is placed on the touchscreen device 200. The game piece may have an additional fourth touch point 370 that is on a hinged portion 375 of the game piece 100. As the user manipulates the game piece 100, he may momentarily depress the hinged portion 375 thereby creating contact with the touchscreen device 200. The momentary touch point 370 may advantageously permit additional functionality within the context of the touchscreen device's application. For example, the game piece 100 may represent a wizard in a fantasy game and may have three touch points on its bottom. The three touch points may provide an indication to the touchscreen device that the wizard game piece is part of the game. When a user wants to cast a spell, the user may depress the momentary touch point, which then contacts the touchscreen device 200. The touchscreen device may recognize the additional touch point and create an effect within the game corresponding to the player casting a spell.

In some embodiments, the game piece 100 may also include an audio input device. The audio input device may include a microphone and any processing and/or circuitry capable of processing analog audio signals. The audio input device may receive audio signals from the touchscreen device 200 or other sources (e.g., a user of the device 200) and may cause the game piece 100 to render one or more effects in response to receiving the audio signals. In addition, in some embodiments, the game piece 100 may also have an audio output device that allows the game piece to generate an audio effect in response to receiving an input signal from the touchscreen device 200 or other source.

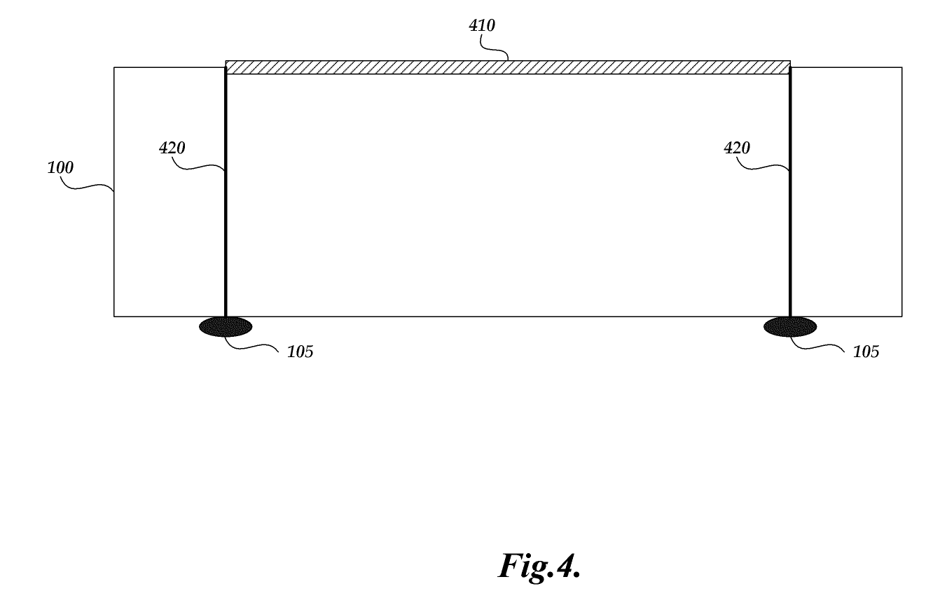

FIG. 4 illustrates a side view of one embodiment of a game piece 100 The game piece comprises a contact surface 410 connecting touch points via a conductive material 420. The contact surface 410 and conductive material 420 may used to transfer the current from the user to the touchscreen such that a capacitor or battery is not required to register a touch event on the touch screen device. In other embodiments, the change in the electric field for one touch point may then be transferred to other touch points creating several touch events to be registered by the touch point computing device. The conductive material 420 may be any conductive material known in the art but must be of sufficiently low resistance to properly transfer current from the user to the touch points to effectuate a touch event.

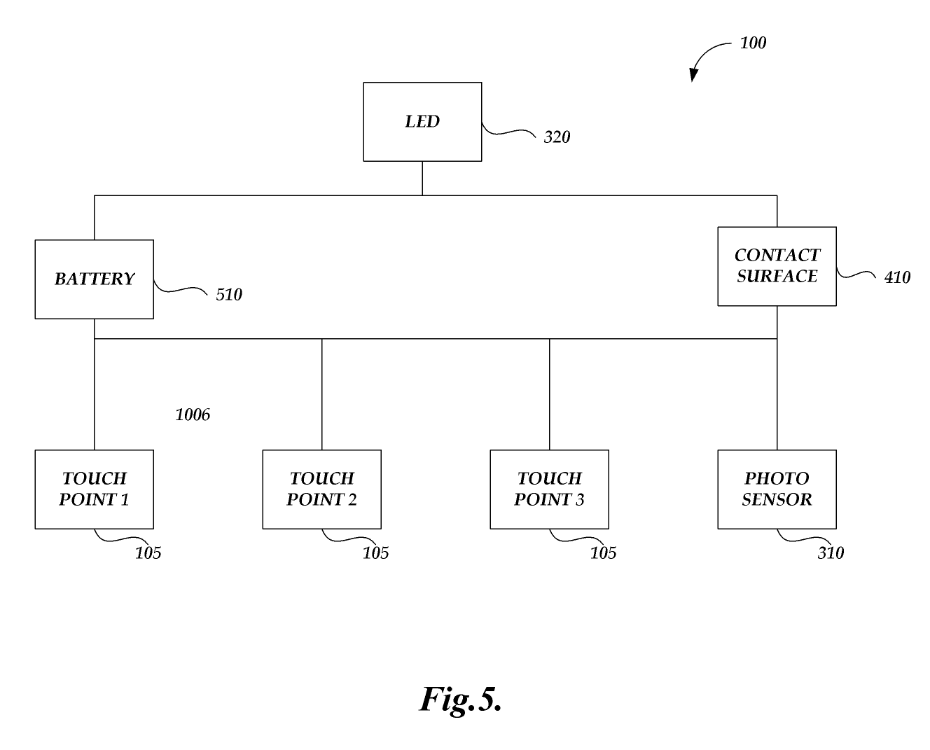

FIG. 5 illustrates a block diagram of the example components of a game piece 100 according to one embodiment. In the embodiments of FIG. 5, the game piece 100 includes three touch points 105, a photo sensor 310, a contact surface 410, a battery 510 and a light emitting diode (LED) 320. In some aspects, the photo sensor 310 may receive light energy from the touchscreen device 200 and charge the battery 510. The battery 510 may also receive charge from the contact surface 410. The contact surface 410 may, for example, be made of conductive material that when touched transfer current from the user to the battery 510. In other embodiments, the contact surface may include a solar cell that captures light and in turn charges the battery 510. In some embodiments, the game piece 100 may also include a capacitor and may not include a battery 510. The battery and/or capacitor may be used to power the touch points 105 so that when the game piece 100 comes in contact with a touch screen device 200, a touch event may be triggered.

In some embodiments, the game piece 100 can be or include another computing device, such as another touch screen computing device. For example, the game piece 100 could be a smartphone and the touch screen device 200 can be a tablet. The smartphone game piece 100 could include an accessory or multiple accessories (e.g., a case, dongle or other type of add-on) that incorporate the touch points 105 and turn a smartphone (or other portable computing device, which may not have telephone capability) into a game piece 100. The features of the smartphone (e.g., battery, display or touch screen, photo lens, photo flash, microphone, speakers, vibration feature, accelerometer, etc.) can be utilized in the function of the game piece 100 in such an arrangement. The accessory or accessories can engage one or more input ports (e.g., data port, headphone port or charging port) of the smartphone in such an arrangement.

### Examples of Process Flow

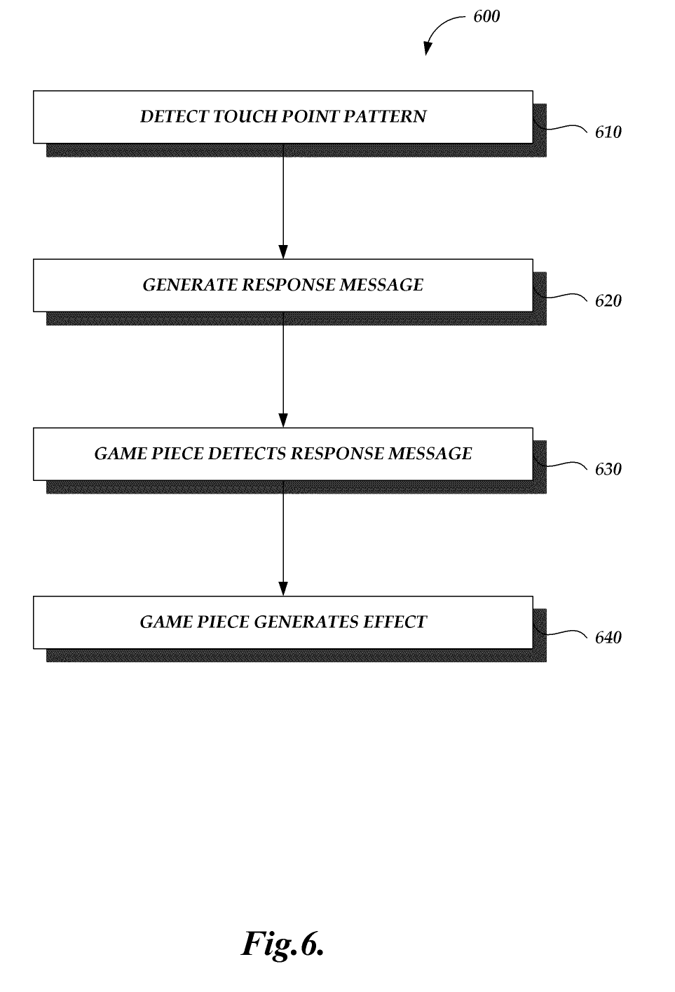

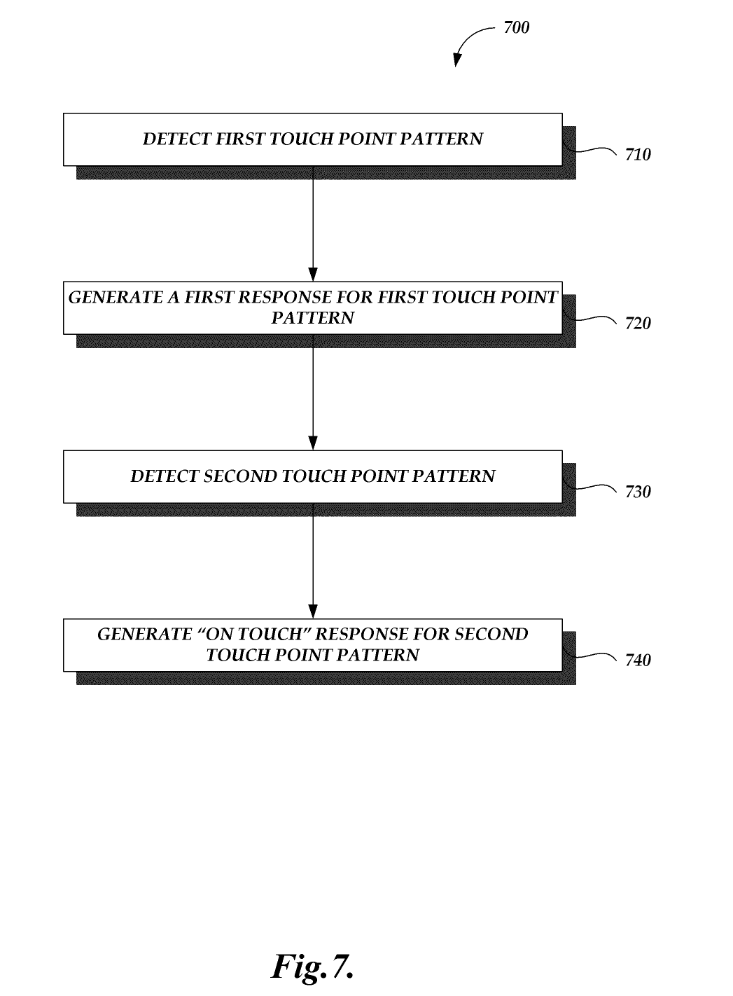

FIGS. 6 and 7 illustrate example process flows that may be implemented by the touchscreen device 200. The touchscreen device 200 may include, for example, a CPU, a memory, and one or more I/O Devices 222 (such as network ports, monitor, keyboard, etc). The touchscreen device may implement the example process flows through one or more modules deployed within the touchscreen device. In general, the word module, as used herein, refers to logic embodied in hardware or firmware, or to a collection of software instructions stored on a non-transitory, tangible computer-readable medium, possibly having entry and exit points, written in a programming language, such as, for example, C, C++, C#, or Java. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules may be stored in any type of tangible computer-readable medium, such as a memory device (e.g., random access, flash memory, and the like), an optical medium (e.g., a CD, DVD, BluRay, and the like), firmware (e.g., an EPROM), or any other storage medium. The software modules may be configured for execution by one or more CPUs in order to cause touchscreen device 200, or other suitable computing device, to perform particular operations.

It will be further appreciated that hardware modules may be comprised of connected logic units, such as gates and flip-flops, and/or may be comprised of programmable units, such as programmable gate arrays or processors. The modules described herein may be implemented as software modules, but may also be implemented in hardware or firmware. Generally, the modules described herein refer to logical modules that may be combined with other modules or divided into sub-modules despite their physical organization or storage.

In one embodiment, touchscreen device 200 may be a computing system that is IBM, Macintosh or Linux/Unix compatible and may include one or more CPUs which may include one or more conventional or proprietary microprocessors such as, an Intel® Pentium® processor, an Intel® Pentium® II processor, an Intel® Pentium® Pro processor, an Intel® Pentium® IV processor, an Intel® Pentium® D processor, an Intel® Core™ processor, an xx86 processor, an 8051 processor, a MIPS processor, a Power PC processor, a SPARC processor, an Alpha processor, for example. The touchscreen device 200 may further include memory, such as random access memory (“RAM”) temporary storage of information and read only memory (“ROM”) for permanent storage of information, The touchscreen device 200 may also include a data store, such as a hard drive, diskette, or optical media storage device. In certain embodiments, memory stores personalized content that may be generated by personalized content generation module 202. Data may be stored in the memory in databases, flat files, spreadsheets, or any other data structure known in the art. Typically, the modules of touchscreen device 200 are in communication with one another via a standards based bus system. In different embodiments, the standards based bus system could be Peripheral Component Interconnect (PCI), Microchannel, SCSI, Industrial Standard Architecture (ISA) and Extended ISA (EISA) architectures, for example. In another embodiment, touchscreen device 200 leverages computing and storage services available over the Internet (cloud computing).

The touchscreen device 200 is generally controlled and coordinated by operating system software, such as the Android, Apple iOS, Microsoft® Windows® 3.X, Microsoft® Windows 98, Microsoft® Windows® 2000, Microsoft® Windows® NT, Microsoft® Windows® CE, Microsoft® Windows® ME, Microsoft® Windows® XP, Windows® 7, Palm Pilot OS, Apple® MacOS®, Disk Operating System (DOS), UNIX, IRIX, Solaris, SunOS, FreeBSD, Linux®, IBM® OS/2® operating systems, or other compatible operating systems. In another embodiment, touchscreen device 200 may be controlled by a proprietary operating system. Conventional operating systems control and schedule computer processes for execution, perform memory management, provide file system, networking, and I/O services, and may provide a user interface, such as a graphical user interface (“GUI”) for display, among other things.

Turning to now to FIG. 6, a process 600 implemented by the touchscreen computing device 200 for detecting a game piece, generating a response message and a game piece receiving the response message and generating an effect is described according to one embodiment. At block 610, process 600 detects the touch point pattern of a game piece 100. In some embodiments, the touch point pattern of the game piece 100 may represent a certain player, state, effect, or be given some other specific attribute that has significance to the play participants using the game piece and the game or application executing on the touchscreen device 200. At block 620, the touchscreen display 200 may generate a response message. In some embodiments, the response message may be a visual or auditory message that the game piece 100 may detect through its photo sensor 310 or in other embodiments, through a microphone, or audio input device, included thereon. After the message has been generated by the touchscreen device 200, the game piece may detect it at block and the game piece may generate an appropriate effect at block 640.

Process 600 may be further explained by example. The touchscreen device 200 may be executing a game with two players. Each player may manipulate a game piece 100 by contacting the game piece 100 with the touchscreen device 200. Each game piece 100 may have a display that shows the players current scores. As the players contact the game pieces 100 with the touchscreen device, the touchscreen device 200 may detect the touch point pattern of the game piece 100. When a scoring event occurs within the game, the touchscreen device 200 may flash a series of lights to the game pieces indicating the players' new scores. The game pieces may detect the patterns and display the corresponding score on their respective displays.

FIG. 7 shows a process 700 implemented by a touchscreen device 200 for detecting two game pieces with different touch point patterns and generating a response for each game piece according to one embodiment. At block 710, the touchscreen device 200 detects the first touch point pattern from the first game piece. The touchscreen device 200 may logically associate the first touch point pattern with a first entity or aspect that has significance within its currently executing application. In response to detecting the first touch point pattern, the touchscreen device may generate a first response or effect at block 720. At block 730, the touchscreen device may detect a second touch point pattern from a second game piece. The touchscreen device 200 may logically associate the second touch point pattern with a second entity or aspect that has significance within its currently executing application. In response to detecting the second touch point pattern, the touchscreen device may generate a second response or effect at block 740.

### Sample Applications

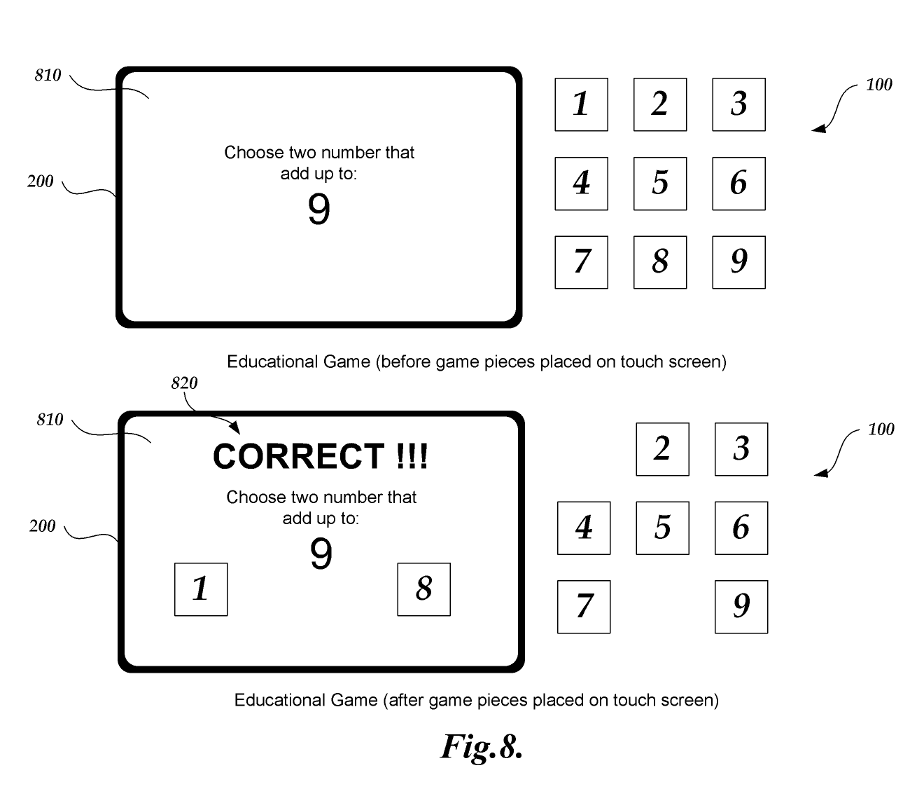

FIG. 8 shows one embodiment of a sample educational application. For example, the game pieces 100 may represent the integers 0-9. Each game piece would have a unique pattern of touch points such that the application would recognize the value associated with each game piece. The application running on the touchscreen computing device may present text 810 asking the user to “Choose two numbers that add up to: 9.” A user may then place any two game pieces on the touchscreen to answer the question. For example, a user may place the game pieces representing the integers 1 and 8, 2 and 7, 3 and 6, etc. When the user answers the question correctly by placing the two integer game pieces on the screen, the touchscreen computer device may generate a response 820 indicating the user is correct. For example, the response may be an auditory response such as a voice saying “Correct!”, or may be a visual response with the words “Correct!!!” The game pieces may also have LEDs on the top of the game pieces and a photo sensor on the bottom of each game piece. When a user answers a question correctly, the touchscreen computing device may generate a signal that the photo sensor detects, and the game pieces may illuminate the LED in response to a correct an answer. The game pieces may also contain logic that allows the photo sensors to detect more than one signal, allowing the game pieces to illuminate one color corresponding to a correct answer (e.g., green) and second color corresponding to an incorrect answer (e.g., red).

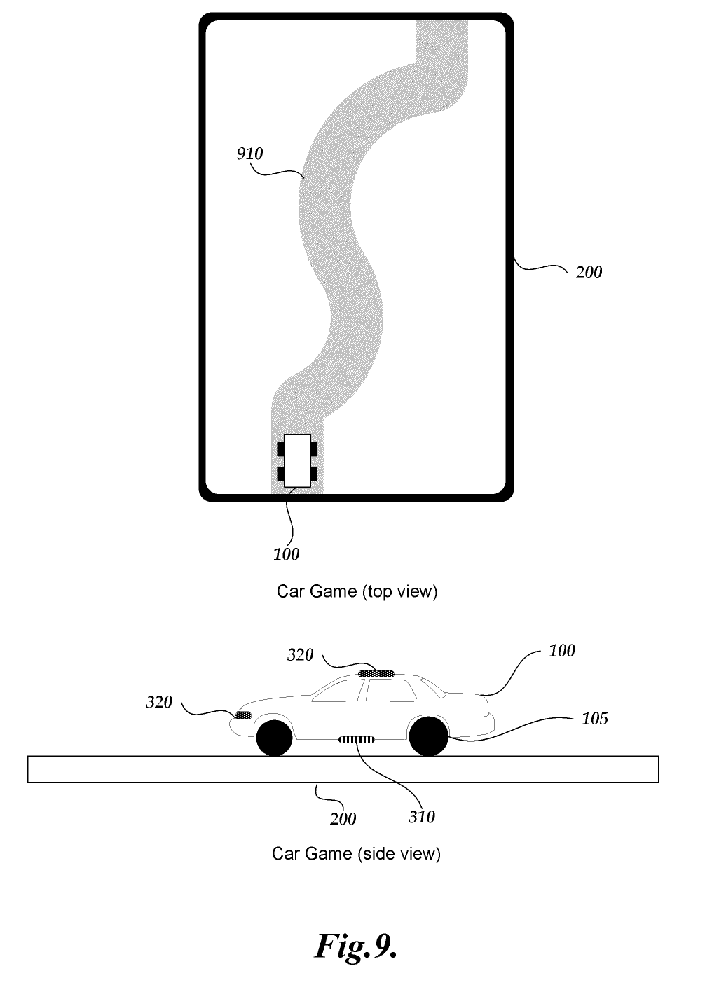

FIG. 9 shows one embodiment of a sample entertainment application. The entertainment application may be a race car game. The game piece 100 may represent a race car. The touchscreen computing device 200 may generate a graphic representing a moving road 910 and the user must move the car-shaped game piece 100 on the touchscreen so that the car remains on the moving road. If the car goes outside of the moving road, the touchscreen may generate a signal. A photo sensor 310 on the underside of the car may detect the signal and generate effects on the game piece such as vibrating or illuminating an LED 320.

The specific dimensions and implementations of any of the embodiments disclosed herein can be readily varied depending upon the intended application, as will be apparent to those of skill in the art in view of the disclosure herein. In a similar manner, certain embodiments refer to specific numbers of components or modules and specific component parts and modules which can also be varied and substituted as will be apparent to those of skill in the art in view of the disclosure herein. In addition, all features discussed in connection with any one embodiment herein can be readily adapted for use in other embodiments herein to form various combinations and sub-combinations. The use of different terms or reference numerals for similar features in different embodiments does not imply differences other than those which may be expressly set forth.

It will be appreciated by those skilled in the art and others that all of the functions described in this disclosure may be embodied in software executed by one or more processors of the disclosed components and mobile communication devices. The software may be persistently stored in any type of non-volatile storage.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art. It will further be appreciated that the data and/or components described above may be stored on a computer-readable medium and loaded into memory of the computing device using a drive mechanism associated with a computer readable storing the computer executable components such as a CD-ROM, DVD-ROM, or network interface further, the component and/or data can be included in a single device or distributed in any manner. Accordingly, general purpose computing devices may be configured to implement the processes, algorithms, and methodology of the present disclosure with the processing and/or execution of the various data and/or components described above.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A game piece apparatus for interacting with a touchscreen computing device, the game piece apparatus comprising:
a plurality of conductive touch points;
an input component operable to receive an input signal from a touchscreen computing device; and,
one or more effect generation components,
wherein the one or more effect generation components generate an effect in response to the input component receiving the input signal from the touchscreen computing device.

2. The game piece apparatus of claim 1 further comprising a battery.

3. The game piece apparatus of claim 1 further comprising a non-transitory computer readable medium operable to store the input signal.

4. The game piece apparatus of claim 1 wherein the input component comprises a photo sensor.

5. The game piece apparatus of claim 1 wherein the input component comprises an audio input unit.

6. The game piece apparatus of claim 1 wherein at least one of the effect generation components generates a visual effect.

7. The game piece apparatus of claim 1 wherein at least one of the effect generation components generates an auditory effect.

8. The game piece apparatus of claim 1 wherein at least one of the effect generation components generates a tactile effect.

9. The game piece apparatus of claim 1 further comprising a momentary touch point.

10. The game piece apparatus of claim 1 further comprising:
a conductive contact surface; and
a low-resistance conductive material,
wherein the constructive contact surface and the plurality of conductive touch points are connected by the low-resistance conductive material.

11. The game piece apparatus of claim 1 further comprising a capacitor.

12. A computer-implemented method of providing an interactive computing application comprising:
as implemented by one or more computing devices configured with specific executable instructions,
detecting a first pattern of first touch points, the first touch points affixed to a first game piece;
detecting a second pattern of second touch points, the second touch points affixed to a second game piece wherein the second pattern of touch points is different than the first pattern of touch points;
generating a first signal comprising a first message, the first message comprising information operable to instruct the first game piece to generate a first effect;
generating a second signal comprising a second message, the second message comprising information operable to instruct the second game piece to generate a second effect, wherein the second message is different from the first message and the second effect is different than the first effect;
communicating the first signal to the first game piece; and,
communicating the second signal to the second game piece

13. The method of claim 12 wherein the first signal and the second signal are signals capable of detection by a photo sensor.

14. The method of claim 13 wherein the first signal and the second signal are communicated by displaying the first message and the second message on a touchscreen.

15. The method of claim 12 wherein the first signal and the second signal are signals capable of detection by an audio input device.

16. The method of claim 15 wherein the first signal and the second signal are communicated by generating an audio signal.

17. A computer-readable, non-transitory storage medium comprising:
one or more computer-executable modules for analyzing data, the one or more computer executable modules configured to:
detect a pattern of conductive touch points of a game piece through a touchscreen;
determine a first effect to generate based at least in part on the detected pattern of conductive touch points;
detect at least one additional conductive touch point, the at least one additional conductive touch point making contact with the touchscreen at the same time as pattern of conductive touch points;
determine a second effect to generate based at least in part on the at least one additional conductive touch point;
generating the first effect, and
generating the second effect.

18. The computer-readable, non-transitory storage medium of claim 17 wherein touchscreen is a capacitive touchscreen.

19. The computer-readable, non-transitory storage medium of claim 17 wherein the first effect or the second effect is a visual effect.

20. The computer-readable, non-transitory storage medium of claim 17 wherein the first effect or the second effect is an audio effect.
